(19) United States
(12) Patent Application Publication
(10) Pub. No.: US 2008/0044696 A1
(43) Pub. Date: Feb. 21, 2008

(54) HYDROGEN GENERATION CARTRIDGE

(76) Inventor: Steven R. Knight, Portland, CT (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(21) Appl. No.: 11/841,187

(22) Filed: Aug. 20, 2007

Related U.S. Application Data
(60) Provisional application No. 60/822,768, filed on Aug. 18, 2006.

(51) Int. Cl. H01M 8/18

(52) U.S. Cl. 429/17; 429/19

(57) ABSTRACT

A hydrogen generation cartridge (12) for supplying hydrogen gas to the anode side of a fuel cell system. The cartridge (12) comprises a first compartment (30) containing a first reactant (32) and a second compartment (34) containing a second reactant (36). The first compartment (30) is positioned within the second compartment (34) and, prior to cartridge activation, the compartments (30,34) chemically isolate the reactants (32/36) from each other. To activate the cartridge (12), the first compartment (30) is opened (e.g., broken) to form a common chamber (40) with the second compartment (34), and the reactants (32/36) combine and react to generate hydrogen gas within this chamber 40.

### RELATED APPLICATION

This application claims priority under 35 U.S.C. §119 (e) to U.S. Provisional Patent Application No. 60/822,768 filed on Aug. 18, 2006. The entire disclosure of this provisional application is hereby incorporated by reference.

### GENERAL FIELD

A cartridge for generating hydrogen for supply to the anode side of a fuel cell system.

### BACKGROUND

A fuel cell system can be employed to provide a DC (direct current) voltage that may be used to power an electrical appliance. A fuel cell, such as a PEM fuel cell, will typically comprise an anode, a cathode, an electrolyte, and a catalyst arranged on each side of the electrolyte. The anode is the negative post of the fuel cell and conducts electrons that are freed from hydrogen molecules such that the electrons can be used as a current in an external circuit. By giving up electrons, the hydrogen molecules become hydrogen ions. The cathode is the positive post of the fuel cell, and conducts the electrons back from the external circuit to the catalyst, where the electrons can recombine with the hydrogen ions and oxygen to form water.

### SUMMARY

A hydrogen generation cartridge is provided to supply hydrogen to the anode side in a fuel cell system. The cartridge comprises a first compartment, for a first reactant, and a second compartment for a second reactant, the compartments being isolated from each other until the cartridge is activated for use in the fuel cell system. Cartridge activation can be accomplished with minimal manual effort and/or without any special tools. The hydrogen generation cartridge can have a compact structure thereby making it particularly suitable for portable-electronic-appliance applications. These and other features of the hydrogen generation cartridge, the fuel cell system, and/or corresponding components/steps are fully described and particularly pointed out in the claims. The following description and annexed drawings set forth in detail a certain illustrative embodiment, this embodiments being indicative of but one of the various ways in which the principles may be employed.

### DRAWINGS

FIG. 1 is a schematic view of a fuel cell system incorporating a hydrogen generating cartridge.

FIG. 2 is a cross-sectional view of the hydrogen-generating cartridge prior to activation.

FIG. 3 is a cross-sectional view of the hydrogen-generating cartridge being activated.

FIG. 4 is a cross-sectional view of the hydrogen-generating cartridge after activation.

### DETAILED DESCRIPTION

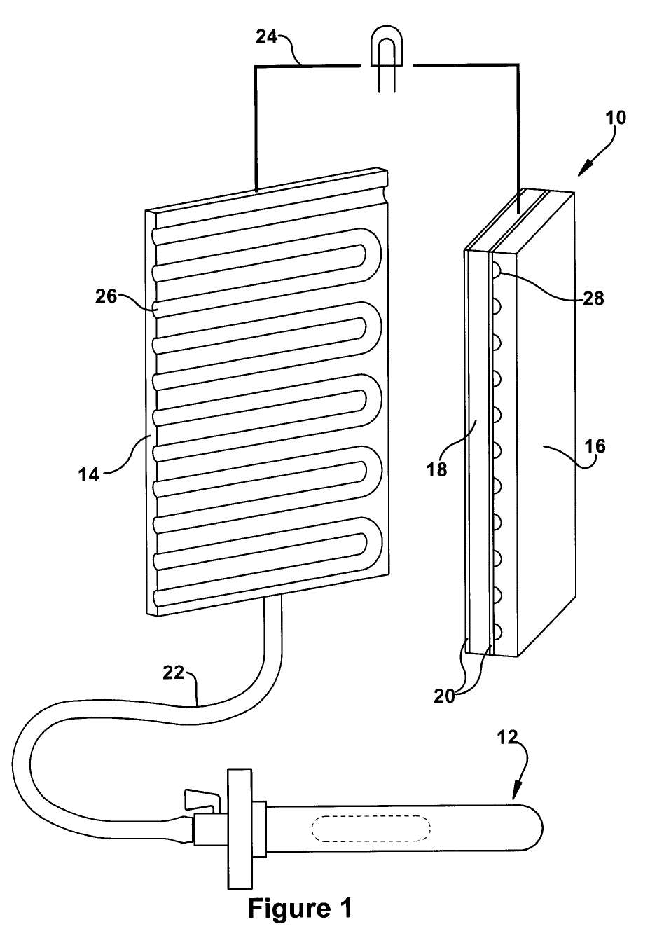

Referring now to the drawings, and initially to FIG. 1, a fuel cell system 10 incorporating a hydrogen generation cartridge 12 is shown. In the illustrated embodiment, the system 10 is a PEM (proton exchange membrane) fuel cell system. This type of fuel cell is typically viewed as one of the most promising in portable fuel cell technologies and uses one of the least complex reactions of any fuel cell. That being said, the hydrogen generation cartridge 12 could be used on or with other types of fuel cell systems.

The fuel cell system 10 comprises an anode 14, a cathode 16, an electrode 18, and catalyst 20. The electrode 18 is sandwiched between the anode 14 and the cathode 16 and the catalyst 20 are arranged on each side of the electrode 18. Supply tubing 22 extends between the hydrogen generation cartridge 12 and the anode 14.

The anode 14 is the negative post of the fuel cell and conducts electrons that are freed from hydrogen molecules such that the electrons can be used as a current in an external circuit 24. The anode 14 includes channels 26 etched therein to disperse hydrogen gas as evenly as possible over the surface of the catalyst 20. By giving up electrons, the hydrogen molecules become hydrogen ions.

The cathode 16 is the positive post of the fuel cell, and has channels 28 etched therein to evenly distribute oxygen (usually air) to the surface of the catalyst 20. The cathode 16 also conducts the electrons back from the external circuit 24 to the catalyst 20, where the electrons can recombine with the hydrogen ions and oxygen to form water. Water is preferably the only by-product of the fuel cell system 10.

The catalyst 20 is typically platinum particles that are thinly coated onto carbon paper or cloth. The catalyst 20 is usually rough and porous so as to increase the surface area of the platinum that can be exposed to the hydrogen or oxygen. However, it would be desirable to further increase catalyst surface area without increasing the dimensions of the catalyst. The catalyst 20 facilitates the reaction of oxygen and hydrogen.

During operation of the fuel cell system 10, hydrogen gas (H₂) from the hydrogen generation cartridge 12 enters the anode side 14 of the fuel cell system 10. When an H₂ molecule comes into contact with the platinum catalyst 20, it splits into two H+ ions and two electrons (e−). The electrons are conducted through the anode 14, where they make their way through the external circuit 24 and return to the cathode side 16 of the fuel cell system 10. On the cathode side 16 of the fuel cell system 10, oxygen gas (O₂) is being forced through the catalyst 20. (In the illustrated embodiment, air is the oxygen source.) As oxygen (O₂) is forced through the catalyst 20, it forms two oxygen atoms, each having a strong negative charge. This negative charge attracts the two H+ ions through the membrane 18, where they combine with an oxygen atom and two of the electrons from the external circuit to form a water molecule (H₂O).

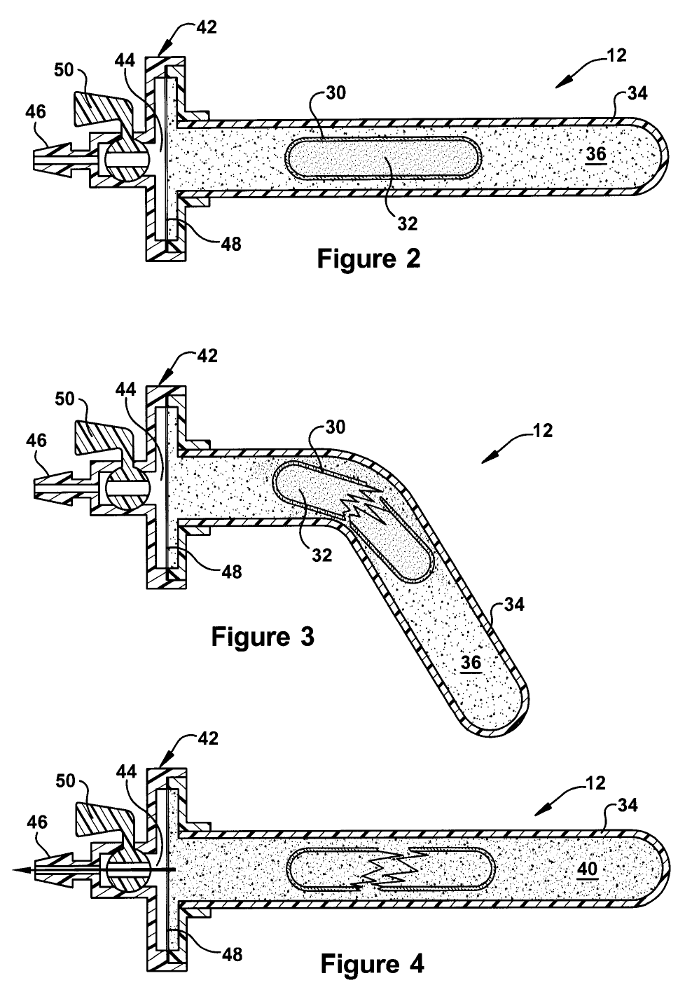

Referring now to FIGS. 2-4, the hydrogen generation cartridge 12 is shown isolated from the rest of the fuel cell system 10. The cartridge 12 comprises a first compartment 30 containing a first reactant 32 and a second compartment 34 containing a second reactant 36. Prior to activation, the compartments 30-34 chemically isolating the first reactant 32 from the second reactant 36. (FIG. 2.) One compartment 30/34 is openable to form a common chamber 40 with the other compartment 34/30. (FIG. 3.) Upon such compartment opening (or cartridge activation), the reactants 32 and 36 combine and react to generate hydrogen gas. (FIG. 4.)

The first reactant 32 can be a solid reactant and the second reactant 36 can be a liquid reactant. The first reactant 32 can be a liquid reactant and the second reactant can be a solid reactant. It may also be possible for both reactants to be solid reactants or for both reactants to be liquid reactants. Reactants in gaseous or vapor stage also may be possible.

The solid reactant can be provided as a solid mass (e.g., rod or bar), pellets, pills, and/or powder. Solid reactants that can comprise chemical hydrides such as, for example, sodium borohydride, lithium borohydride, lithium aluminum hydride, lithium hydride, sodium hydride, and/or calcium hydride. Liquid reactants can comprise, for example, water, acid, alcohol, and/or solutions-mixtures thereof.

In the illustrated embodiment, the first compartment 30 is positioned within the second compartment 34, and the first compartment 30 is the openable compartment. The compartment can be made of a fracturable material, such as glass or a shatterable plastic. Preferably, the breakable compartment 30 is easily breakable by manual force whereby no special tools or force is necessary for cartridge activation. The hydrogen generation cartridge 12 can comprise more than one breakable compartment 30. Also in the illustrated embodiment, the second compartment 34 is preferably not openable and/or not breakable. For example, the compartment 30 can be made of flexible material, such as a plastic or rubber material. In this manner, cartridge activation can be accomplished by bending the reactant compartment 34 to force fracture of the breakable compartment 30.

Other compartment-opening techniques are certainly possible and contemplated. For example, the second compartment 34 need not be bendable, and could instead just be able to withstand a shatter-inducing slam against a table or other surface. The first compartment 30 could have designed-weakness seams or other means for facilitating breakage in a predictable manner. Instead of force-induced breaking, the cartridge 12 could comprise a piston-like device adapted to puncture or otherwise pierce the relevant compartment 30/34 for activation purposes. A valve or other gate-like device could also be employed to provide selective de-isolation of the reactants 32 and 36 within the compartments 30 and 34.

The hydrogen generation cartridge 12 can further comprise an outlet device 42 with an outlet 44 through generated hydrogen exits the common chamber 40. The outlet device 42 can have a connection 46 for mating with the anode supply tube 20, a filter 48 for filtering the generated hydrogen, and/or a valve 50 for opening-closing the outlet 44. If the valve 50 is closed after cartridge activation, the reaction will stop once the pressure in the common chamber 40 reaches a predetermined level (e.g., 5 psi). In most circumstances, a regulator upstream of the anode 14 is not required. That being said, the fuel cell system 10 could incorporate a regulator, a manifold, an accumulator, and/or other convention devices as necessary or desired.

Although the fuel cell system 10, the hydrogen generation cartridge 12, the compartments 30/34, and other components, steps or methods, have been shown and described with respect to a certain embodiments, it is obvious that equivalent alterations and modifications will occur to others skilled in the art upon the reading and understanding of this specification and the annexed drawings. In regard to the various functions performed by the above described elements (e.g., components, assemblies, systems, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function. In addition, while a particular feature of the invention may have been described above with respect to only one or more of several illustrated embodiments, such feature may be combined with one or more other features of the other embodiments, as may be desired and advantageous for any given or particular application.

1. A hydrogen generation cartridge, comprising a first compartment containing a first reactant and a second compartment containing a second reactant;
the compartments chemically isolating the first and second reactants;
one compartment being openable to form a common chamber with the other compartment wherein the first reactant and the second reactant combine and react to generate hydrogen gas.

2. A hydrogen generation cartridge as set forth in claim 1, wherein the first compartment is positioned within the second compartment.

3. A hydrogen generation cartridge as set forth in claim 3, wherein the first compartment is the openable compartment.

4. A hydrogen generation cartridge as set forth in claim 1, further comprising an outlet device with an outlet through which generated hydrogen exits the common chamber.

5. A hydrogen generation cartridge as set forth in claim 5, wherein the outlet device comprises a filter which filters the generated hydrogen upon exiting the common chamber.

6. A hydrogen generation cartridge as set forth in claim 5, wherein the outlet device comprises a valve for opening-closing the outlet.

7. A hydrogen generation cartridge as set forth in claim 1, wherein the first reactant and/or the second reactant is a liquid reactant.

8. A hydrogen generation cartridge as set forth in claim 7, wherein the liquid reactant comprises water, acid, and/or alcohol solutions.

9. A hydrogen generation cartridge as set forth in claim 1, wherein the first reactant and/or the second reactant is a solid reactant.

10. A hydrogen generation cartridge as set forth in claim 9, wherein the solid reactant comprises a chemical hydride.

11. A hydrogen generation cartridge as set forth in claim 1, wherein one of the first reactant and the second reactant is a liquid reactant and the other of the first reactant and the second reactant is a solid reactant.

12. A hydrogen generation cartridge as set forth in claim 1, wherein the first compartment is the openable compartment and is positioned within the second compartment and wherein the first reactant is a liquid reactant and the second reactant is a solid reactant.

13. A hydrogen generation cartridge as set forth in the claim 1, wherein the openable compartment is a breakable compartment.

14. A hydrogen generation cartridge as set forth in claim 13, wherein the breakable compartment is made of fracturable material.

15. A hydrogen generation cartridge as set forth in claim 13, wherein the compartment other than the breakable compartment is made of a flexible material.

16. A fuel cell system comprising an anode, a cathode, an electrolyte, and the hydrogen generation cartridge as set forth in claim 1 for supplying hydrogen to the anode.

17. A method of supplying hydrogen to a fuel cell system, said method comprising the step of:
opening the openable compartment of the hydrogen generation cartridge of claim 1 to form the common chamber wherein the reactants react to generate hydrogen gas; and
fluidly connecting the outlet of the common chamber to the fuel cell.

18. A method as set forth in claim 17, wherein the first compartment is positioned within the second compartment and said opening step comprises opening the first compartment to form the common chamber within the second compartment.

19. A method as set forth in the claim 17, wherein said opening step comprises breaking the second compartment to form the common chamber within the second compartment.
